(19) United States
(12) Patent Application Publication
(10) Pub. No.: US 2014/0351738 A1
(43) Pub. Date: Nov. 27, 2014

(54) Patient Monitoring System User Interface

(71) Applicant: Draeger Medical Systems, Inc, Telford, PA (US)

(72) Inventors: Georgios Kokovidis, Waltham, MA (US); Alessandro Simone Agnello, Peabody, MA (US)

(73) Assignee: Draeger Medical Systems, Inc., Telford, PA (US)

(21) Appl. No.: 14/363,762

(22) PCT Filed: Dec. 14, 2011
(86) PCT No.: PCT/US11/64994

§ 371 Date: Jun. 6, 2014

(51) Int. Cl. G06F 19/00; G06F 3/0484; G06F 3/0488

(52) U.S. Cl. CPC G06F 19/3406; G06F 3/0488; G06F 3/04842
USPC 715/771

(57) ABSTRACT

A graphical user interface is rendered in a display of a patient monitoring system having a touchscreen interface that also includes or is coupled to at least one sensor monitoring one or more physiological parameters of a patient. The graphical user interface displays at least one waveform derived from the at least one sensor with each waveform having a temporal dimension extending along an x-axis and a value dimension extending along a y-axis and with the values of the waveform varying over time. Thereafter, user-generated input is received via the touchscreen interface of the display selecting a waveform and comprising at least one gesture. In response, the display of the selected waveform is adjusted concurrently or substantially concurrently with the user-generated input to adjust a view of the selected waveform based on the user-generated input while maintaining a view of any non-selected waveforms. Related apparatus, systems, techniques and articles are also described.

### TECHNICAL FIELD

The subject matter described herein relates to patient monitoring systems having enhanced interfaces for viewing patient data such as waveforms.

### BACKGROUND

Patient monitoring systems play a crucial role in assessing and monitoring the well-being of patients receiving care (whether during a procedure or as part of recovery). Various vital signs such as ECG, basic arrhythmia, respiration, pulse rate, temperature, noninvasive blood pressure and SpO2 can be simultaneously displayed. Some of these vital signs are displayed as waveforms that have values which vary over time. With such waveforms, older values are replaced by newer values as time progresses. In some cases, caregivers (e.g., nurses, doctors, technicians, etc.) need to review a certain segment of the waveforms. In some cases, a segment which is no longer displayed needs to be reviewed and/or a particular feature in a segment needs to be enlarged. Conventional patient monitoring systems typically include an input interface such as a keypad and/or buttons adjacent to a display to adjust how a particular waveform is rendered. However, such interfaces can benefit from enhanced usability in an effort to increase and/or maintain a high level of patient care.

### SUMMARY

In a first aspect, a graphical user interface is rendered in a display having a touchscreen interface. The display is part of a patient monitoring system that includes or is coupled to at least one sensor monitoring one or more physiological parameters of a patient. The graphical user interface displays at least one waveform derived from the at least one sensor with each waveform having a temporal dimension extending along an x-axis and a value dimension extending along a y-axis and with the values of the waveform varying over time. Thereafter, user-generated input is received via the touchscreen interface of the display selecting a waveform and comprising at least one gesture. In response, the display of the selected waveform is adjusted concurrently or substantially concurrently with the user-generated input to adjust a view of the selected waveform based on the user-generated input while maintaining a view of any non-selected waveforms.

In some implementations, there are at least two waveforms being displayed within the graphical user interface.

A wide variety of gestures can be utilized. For example, the gesture(s) can include extending inwardly from two touch points on the touchscreen interface in at least one of the x-axis or the y-axis of the selected waveform (i.e., a pinch and zoom-out movement, etc.). The gestures can include extending outwardly from two touch points on the touchscreen interface in at least one of the x-axis or the y-axis of the selected waveform (e.g., a pinch and zoom-in movement, etc.). With such gestures, a scale of values in the selected waveform can be modified while a scale of values for any non-selected waveforms are maintained. In addition, the gesture can comprise swiping, from one of touch point on the touchscreen interface overlaying the selected waveform, along the x-axis of the selected waveform in a first direction. With some gestures including a swiping gesture, a displayed time period of the selected waveform along the x-axis of the selected waveform is modified based on the adjusting while a displayed time period along the x-axis of any non-selected waveforms is maintained. In addition, it will be appreciated that multiple gestures can be used such that a first gesture selects the selected waveform and a second gesture adjusts the view of the selected waveform.

In addition, inactivity of a selected waveform after a certain period of time, such as 1 minute, can cause the view of the selected waveform to revert a default display setting. The adjusted views of the selected waveform can be continuously updated with new data acquired from the at least one sensor or it can remain static while new data is acquired from the at least one sensor.

In a further interrelated aspect, a patient monitoring system is provided that comprises a display having a touchscreen interface, a sensor interface coupled to at least one sensor monitoring one or more physiological parameters of a patient, at least one data processor, and memory. The memory stores instructions, which when executed, cause the at least one data processor to perform operations including rendering a graphical user interface in a display having a touchscreen interface (the display being part of a patient monitoring system comprising or coupled to at least one sensor monitoring one or more physiological parameters of a patient, the graphical user interface separately displaying at least one waveform derived from the at least one sensor, each waveform having a temporal dimension extending along an x-axis and a value dimension extending along a y-axis, the values of the waveform varying over time), receiving user-generated input via the touchscreen interface of the display selecting a waveform and comprising at least one gesture, and adjusting the display of the selected waveform concurrently or substantially concurrently with the user-generated input to adjust a view of the selected waveform based on the user-generated input while maintaining a view of any non-selected waveforms.

In another interrelated aspect, rendering a graphical user interface in a display of a patient monitoring system having a touchscreen interface. The display forms part of a patient monitoring system including or coupled to at least one sensor monitoring one or more physiological parameters of a patient. The graphical user interface displays at least one waveform derived from the at least one sensor with each waveform having a temporal dimension extending along an x-axis and a value dimension extending along a y-axis, the values of the waveform varying over time. User-generated input is received via the touchscreen interface of the display that selects one of the waveforms and extends, either inwardly or outwardly, in at least one of the x-axis or the y-axis of the selected waveform. Thereafter, display of the selected waveform is adjusted concurrently or substantially concurrently with the user-generated input to adjust a scale of the selected waveform based on the user-generated input while maintaining a scale of any non-selected waveforms.

Articles of manufacture are also described that comprise computer executable instructions permanently stored on computer readable media, which, when executed by at least one data processor, causes the at least one data processor to perform operations herein. Similarly, computer systems are also described that may include at least one processor and memory coupled to the at least one processor. The memory may temporarily or permanently store one or more programs that cause the at least one processor to perform one or more of the operations described herein. In addition, methods can be implemented by one or more data processors either within a single computing system or distributed among two or more computing systems.

The subject matter described herein provides many advantages. For example, the current subject matter provides user interfaces to allow a caregiver to more selectively review selected portions of waveforms for a patient. By providing a patient monitoring system with a touchscreen interface, a caregiver can avoid the need of using one or more physical input devices adjacent to a display in order to get more information about some aspect of a waveform while not affecting other data being displayed (e.g., other waveforms, etc.). In addition, the current subject matter is also advantageous in that it can allow for a patient monitoring system having a smaller form factor.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method for adjusting views of waveforms displayed on a patient monitoring system in response to user-generated input via a display having a touchscreen interface;

FIG. 2 is a system diagram illustrating a patient monitoring system coupled to a patient and being used by a caregiver;

FIG. 3 is a diagram illustrating a view of a display of the patient monitoring system as in FIG. 1;

FIG. 4 is a diagram illustrating a first gesture being received on a display as in FIG. 3;

FIG. 5 is a diagram illustrating an adjusted view of the display in response to the first gesture of FIG. 4;

FIG. 6 is a diagram illustrating a second gesture being received on a display as in FIG. 3;

FIG. 7 is a diagram illustrating an adjusted view of the display in response to the second gesture of FIG. 6;

FIG. 8 is a diagram illustrating a third gesture being received on a display as in FIG. 3; and

FIG. 9 is a diagram illustrating an adjusted view of the display in response to the third gesture of FIG. 8.

Like reference symbols in the various drawings indicate like elements.

### DETAILED DESCRIPTION

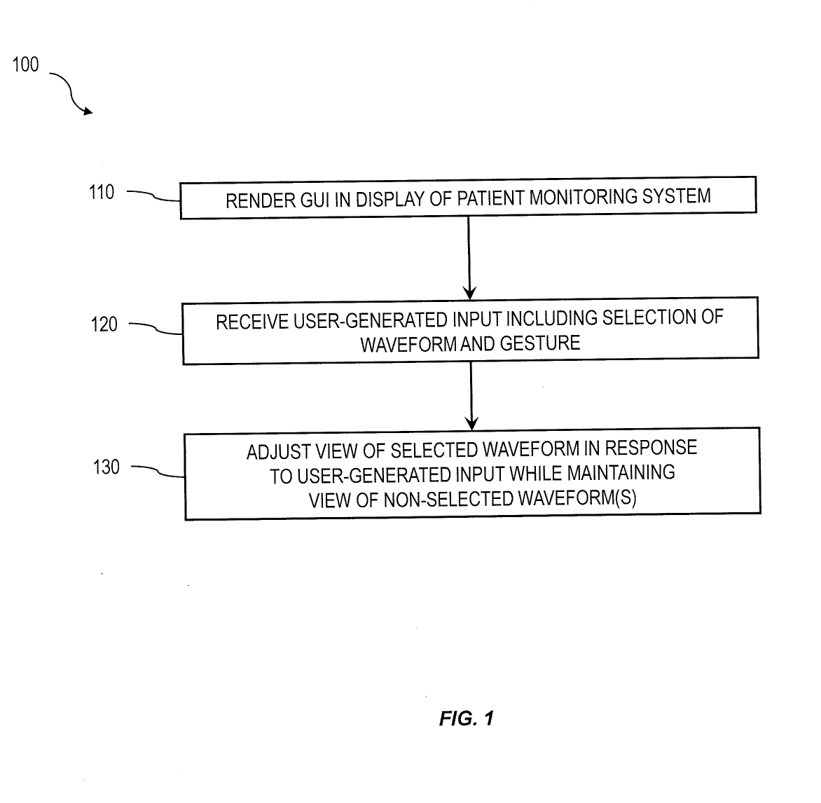

FIG. 1 is a process flow diagram 100 in which, at 110, a graphical user interface is rendered in a display of a patient monitoring system having a touchscreen interface. The patient monitoring system includes or is coupled to at least one sensor monitoring one or more physiological parameters of a patient. The graphical user interface separately displays at least two waveforms derived from the at least one sensor with each waveform having a temporal dimension extending along an x-axis and a value dimension extending along a y-axis, the values of the waveform varying over time. Thereafter, at 120, user-generated input is received via the touchscreen interface of the display selecting one of the waveforms and comprising at least one gesture. In response, at 130, the display of the selected waveform is adjusted concurrently or substantially concurrently with the user-generated input to adjust a view of the selected waveform based on the user-generated input while maintaining a view of any non-selected waveforms.

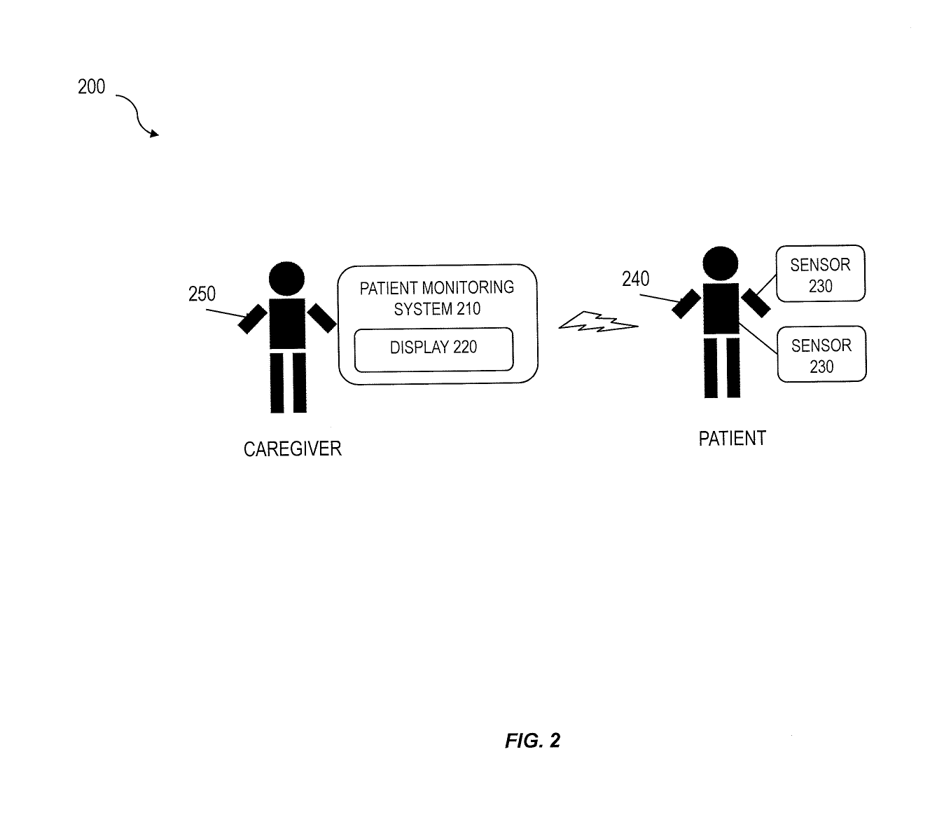

FIG. 2 is a diagram 200 illustrating a patient monitoring system 210 having a display 220. The patient monitoring system 210 comprises at least one data processor and memory to store instructions for execution by the at least one data processor. In addition, the patient monitoring system 210 includes or can be coupled to at least one sensor 230. The at least one sensor 230 in turn is coupled to and monitors the wellbeing of a patient 240. As will be described in further detail below, the display 220 renders a graphical user interface with data characterizing measurements by the at least one sensor 230. The display 220 includes a touchscreen interface (e.g., a multi-touch tablet screen, etc.) that can enable a user 250 to modify how data is being presented in the display 220. The display 220 can be integrated with a device interfacing the sensor(s) 230 or it can comprise a tablet computer (e.g., IPAD, etc.) which is portable and coupled to the sensor(s) via a wired or wireless network.

The sensor(s) 230 can comprise any type of sensor that can characterize a physiological parameter of the patient 240. Sample sensors 230 include, but are not limited to: ECG, basic arrhythmia, respiration, pulse rate, temperature, noninvasive blood pressure, and SpO2 sensors. Waveform, as used herein, describes any type of measurement which can vary over time and be presented with a varying value along a y-dimension.

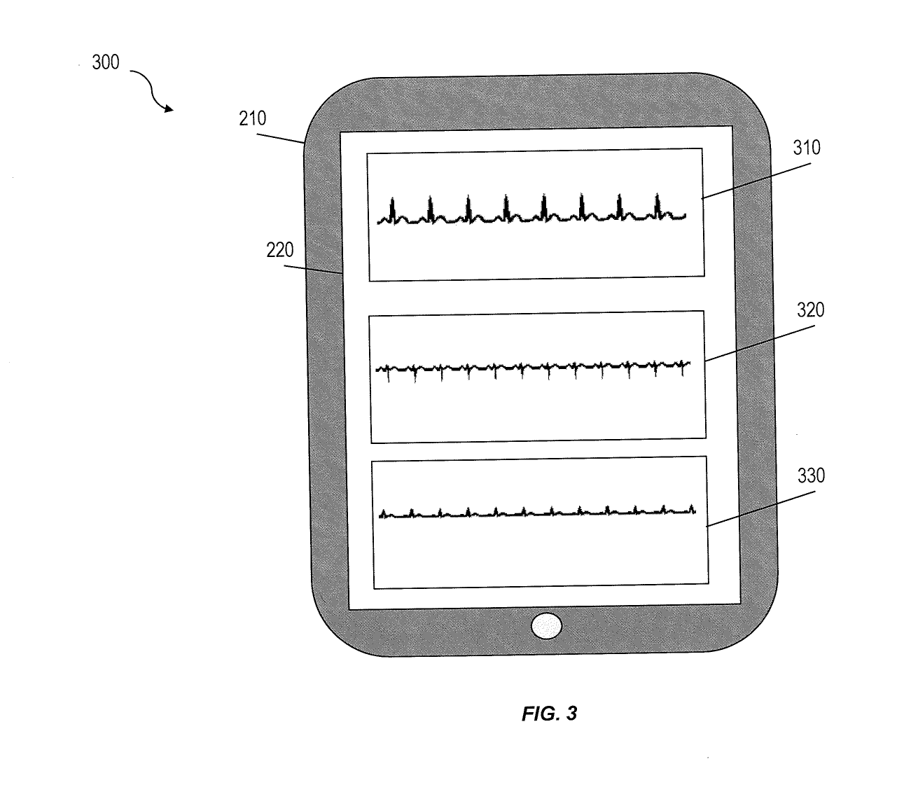

FIG. 3 is a diagram 300 illustrating the display 220 of the patient monitoring system 210 while it renders three waveforms 310, 320, 330. It will be appreciated that the subject matter described herein is implemented with any number of waveforms so long as there are is at least one least waveform. Each of these waveforms 310-330 are based on data obtained from the at least one sensor 230. In one example, the waveforms have an x-axis which is a temporal dimension and a y-axis which is a value dimension. For example, the waveforms can comprise an ECG waveform in which the y-axis represents varying cardio measurements in relation to time. The user 250, via the display, can modify how one of the waveforms 310-330 is rendered while, at the same time, the other waveforms are not modified.

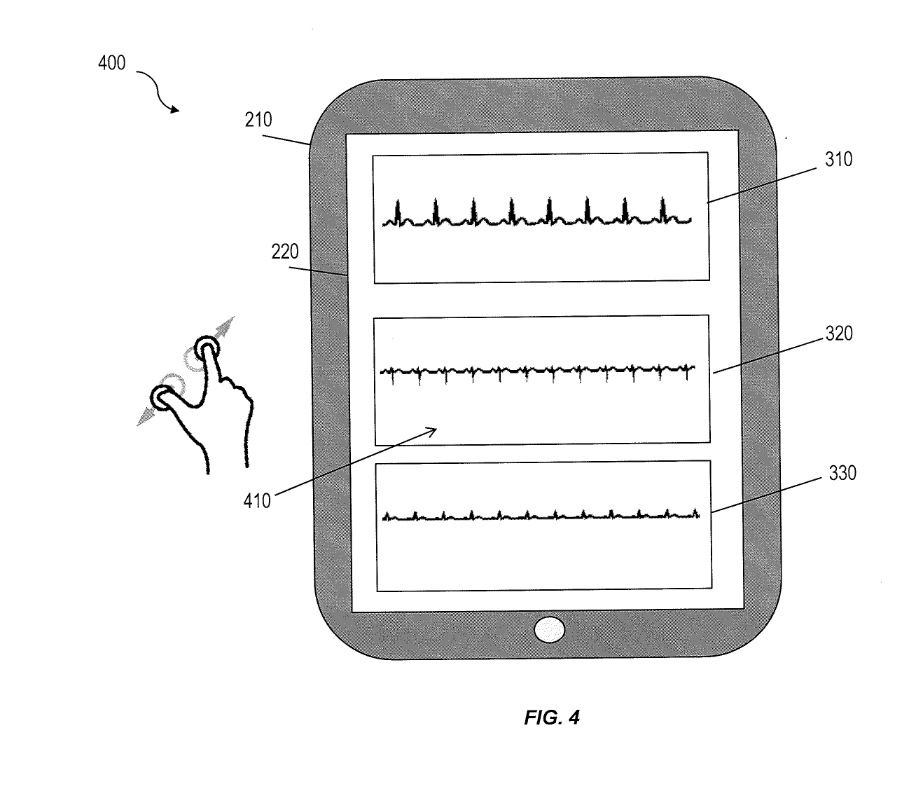

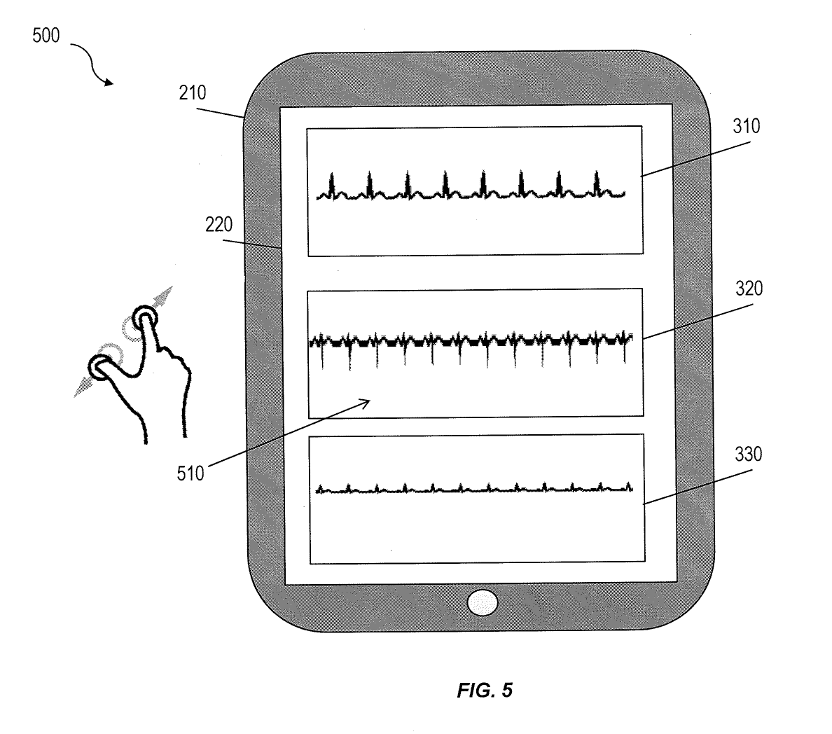

FIGS. 4 and 5 are diagrams 400 and 500 that illustrate a “pinch and zoom-in” gesture. The user 250 can select one of the three waveforms 320 via the touchscreen interface of the display 220 (this selection can comprise a separate gesture of holding one or two figures over the waveform 320 for a pre-defined period of time, etc.). Selecting simply requires the user 250 to touch the waveform 320 on the display 220. Coincident and/or subsequent to the selection of the waveform 320, the user 250 (i) places two fingers on the display 220 over an area 410 of the waveform 320 that he or she desires to enlarge, and (ii) moves his or her fingers in an outward motion. Thereafter, a different view 510 of the waveform 320 is displayed which enlarges a portion of the waveform 320 that corresponds to the area 410. The user 250 can move his or her fingers along one or more of the x-axis and the y-axis of the waveform 320. For example, a diagonal motion will cause both the scale of values along the x-axis and the y-axis of the waveform 320 to be reduced (i.e., the range of values are decreased along both axes). A horizontal motion will cause the scale of values along the x-axis to be reduced and a vertical motion will cause the scale of values along the y-axis to be reduced (and in both cases a smaller portion of the waveform 320 is displayed).

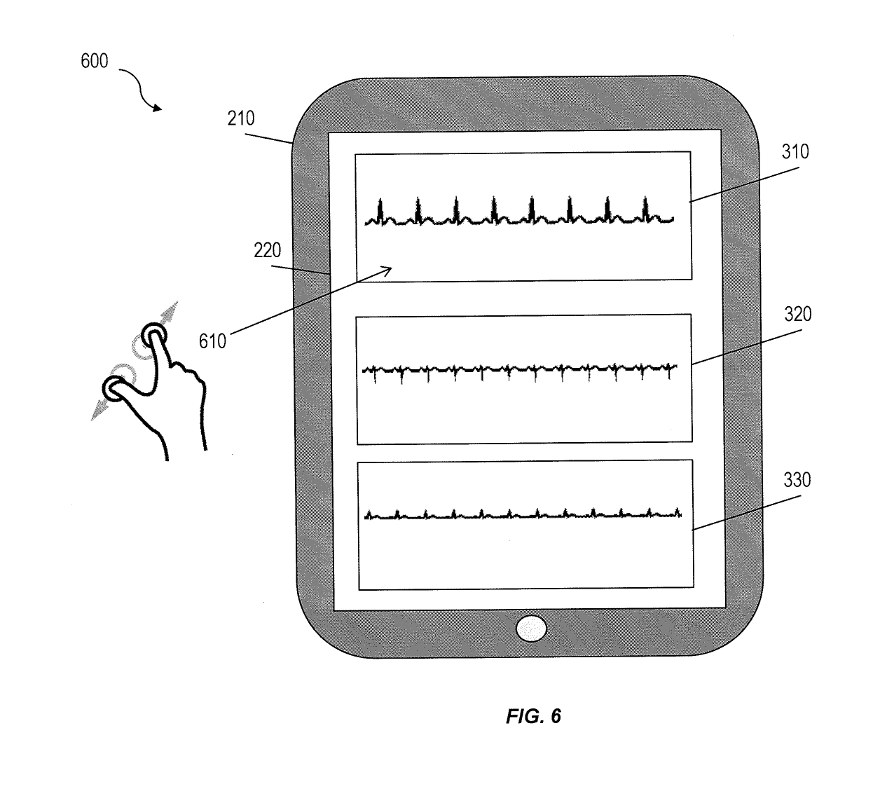

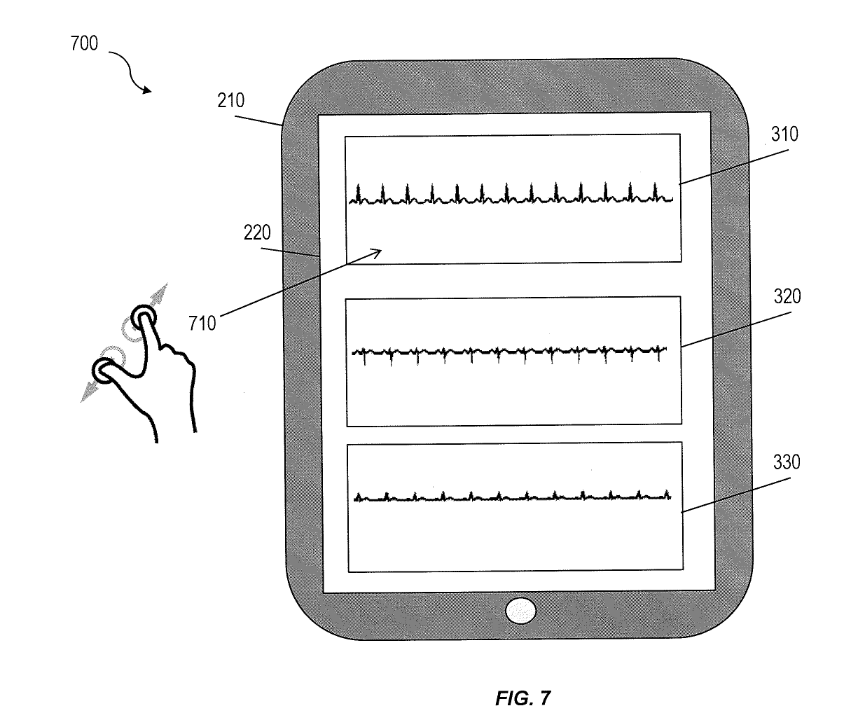

FIGS. 6 and 7 are diagrams 600 and 700 that illustrate a “pinch and zoom-out” gesture. The user 250 can select one of the three waveforms 310 via the touchscreen interface of the display 220. Selecting simply requires the user 250 to touch the waveform 310 on the display 220. Coincident and/or subsequent to the selection of the waveform 310, the user 250 (i) places two fingers on the display 220 over an area 610 of the waveform 310 that he or she desires to make smaller, and (ii) moves his or her fingers in an inward motion. Thereafter, a different view 710 of the waveform 310 is displayed which makes a portion of the waveform 310 that corresponds to the area 610 smaller—while at the same time displaying portions of the waveform 310 that were not previously displayed. The user 250 can move his or her fingers along one or more of the x-axis and the y-axis of the waveform 310. For example, a diagonal motion will cause both the scale of values along the x-axis and the y-axis of the waveform 310 to be increased (i.e., the range of values are increased along both axes). A horizontal motion will cause the scale of values along the x-axis to be increased and a vertical motion will cause the scale of values along the y-axis to be increased (and in both cases a larger portion of the waveform 310 is displayed).

With the zooming operations of FIGS. 4-8, the displayed view can either be static with regard to data acquired by the sensor(s) 230 or it can be applied to new data as it is acquired.

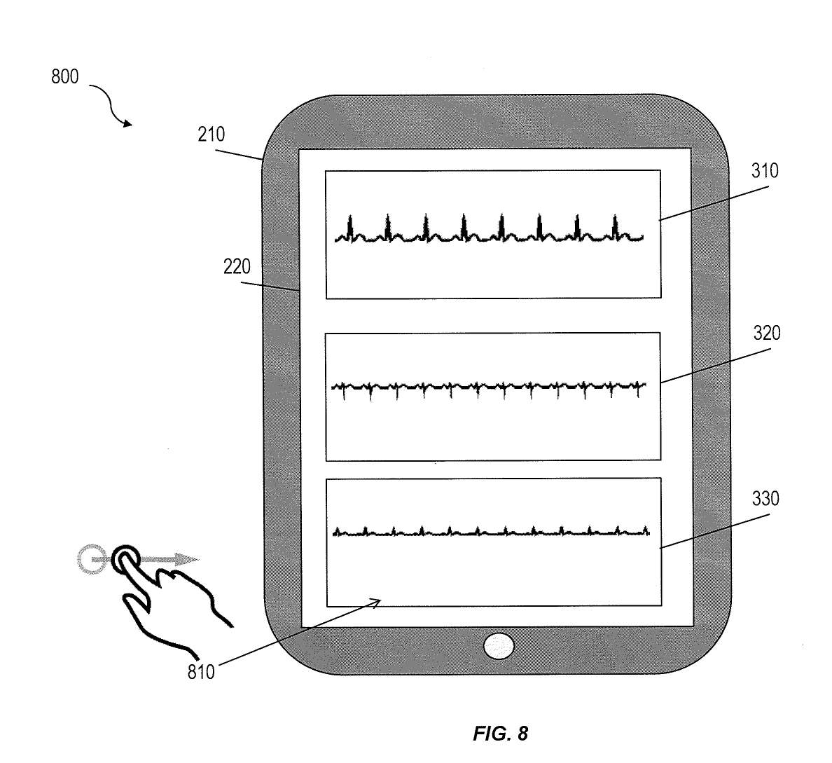

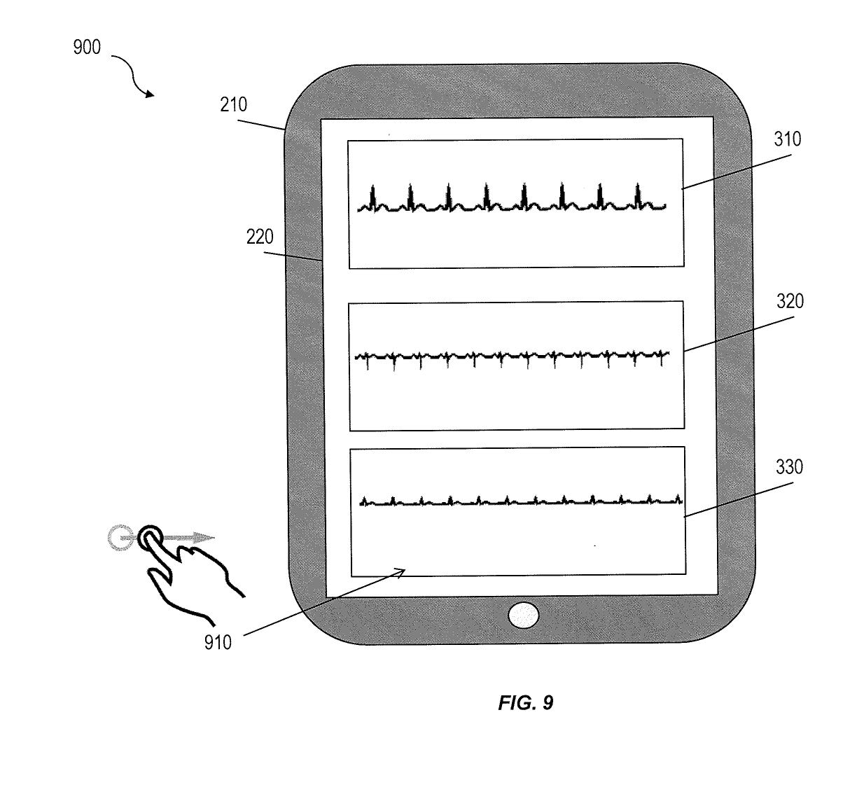

FIGS. 8 and 9 are diagrams 800 and 900 that illustrate a sliding gesture. The user 250 can select one of the three waveforms 330 via the touchscreen interface of the display 220. Selecting simply requires the user 250 to touch the waveform 330 on the display 220. Coincident and/or subsequent to the selection of the waveform 330, the user 250 (i) places at least one finger on the display 220 over an area 810 of the waveform 330 that he or she desires to move horizontally, and (ii) moves his or her fingers in a lateral (i.e., horizontal) motion. Thereafter, a different view 910 of the waveform 330 is displayed which includes a different portion of the waveform 330 (different time values along the x-axis with the corresponding values along the y-axis).

With the any of the above-implementations, a timeout feature can be employed such that the selected waveform reverts back to default display settings after a pre-defined period of time (e.g., 1, 2, 3, 4, 5 minutes, etc.). In addition, a selected waveform can simply be de-selected (e.g., by single tap, double tap, etc.) which would also result in the selected waveform reverting back to default settings.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, it will be appreciated that multiple gestures may be combined to provide different views of selected waveforms. Other embodiments may be within the scope of the following claims.

1-20. (canceled)

21. A method comprising:
rendering a graphical user interface in a display having a touchscreen interface, the display being part of a patient monitoring system comprising or coupled to at least one sensor monitoring one or more physiological parameters of a patient, the graphical user interface separately displaying at least one waveform derived from the at least one sensor, each waveform having a temporal dimension extending along an x-axis and a value dimension extending along a y-axis, the values of the waveform varying over time;
receiving user-generated input via the touchscreen interface of the display selecting a waveform and comprising at least one gesture; and
adjusting the display of the selected waveform concurrently or substantially concurrently with the user-generated input to modify a view of the selected waveform based on the user-generated input while maintaining a view of any non-selected waveforms.

22. A method as in claim 21, wherein there are at least two waveforms.

23. A method as in claim 21, wherein the gesture comprises extending inwardly from two touch points on the touchscreen interface in at least one of the x-axis or the y-axis of the selected waveform.

24. A method as in claim 22, wherein the gesture comprises a pinch and zoom-out movement.

25. A method as in claim 21, wherein the gesture comprises extending outwardly from two touch points on the touchscreen interface in at least one of the x-axis or the y-axis of the selected waveform.

26. A method as in claim 24, wherein the gesture comprises a pinch and zoom-in movement.

27. A method as in claim 21, wherein a scale of values in the selected waveform are modified while a scale of values for any non-selected waveforms are maintained.

28. A method as in claim 21, wherein the gesture comprises swiping, from one touch point on the touchscreen interface overlaying the selected waveform, along the x-axis of the selected waveform in a first direction.

29. A method as in claim 27, wherein a displayed time period of the selected waveform along the x-axis of the selected waveform is modified based on the adjusting while a displayed time period along the x-axis of any non-selected waveforms is maintained.

30. A method as in claim 21, wherein the user-generated input comprises at least two gestures, a first gesture selecting the selected waveform and a second gesture modifying a view of the selected waveform.

31. A method as in claim 21, further comprising:
reverting the view of the selected waveform to a default display setting after expiration of a pre-defined time period.

32. A method as in claim 21, wherein the adjusted view of the selected waveform is continuously updated with new data acquired from the at least one sensor.

33. A method as in claim 21, wherein the adjusted view of the selected waveform remain static while new data is acquired from the at least one sensor.

34. A patient monitoring system comprising:
a display having a touchscreen interface;
a sensor interface coupled to at least one sensor monitoring one or more physiological parameters of a patient;
at least one data processor;
memory storing instructions, which when executed, cause the at least one data processor to perform operations comprising:
rendering a graphical user interface in a display having a touchscreen interface, the display being part of a patient monitoring system comprising or coupled to at least one sensor monitoring one or more physiological parameters of a patient, the graphical user interface separately displaying at least one waveform derived from the at least one sensor, each waveform having a temporal dimension extending along an x-axis and a value dimension extending along a y-axis, the values of the waveform varying over time;
receiving user-generated input via the touchscreen interface of the display selecting a waveform and comprising at least one gesture; and
adjusting the display of the selected waveform concurrently or substantially concurrently with the user-generated input to modify a view of the selected waveform based on the user-generated input while maintaining a view of any non-selected waveforms.

35. A system as in claim 34, wherein there are at least two waveforms.

36. A system as in claim 34, wherein the gesture comprises extending inwardly from two touch points on the touchscreen interface in at least one of the x-axis or the y-axis of the selected waveform.

37. A system as in claim 34, wherein the gesture comprises extending outwardly from two touch points on the touchscreen interface in at least one of the x-axis or the y-axis of the selected waveform.

38. A system as in claim 21, wherein the gesture comprises swiping, from one touch point on the touchscreen interface overlaying the selected waveform, along the x-axis of the selected waveform in a first direction.

39. A method comprising:
rendering a graphical user interface in a display having a touchscreen interface, the display being part of a patient monitoring system comprising or coupled to at least one sensor monitoring one or more physiological parameters of a patient, the graphical user interface separately displaying at least one waveform derived from the at least one sensor, each waveform having a temporal dimension extending along an x-axis and a value dimension extending along a y-axis, the values of the waveform varying over time;
receiving user-generated input via the touchscreen interface of the display selecting a waveform and comprising at least one gesture; and
adjusting, based on the user-generated input, the display of the selected waveform concurrently or substantially concurrently with the user-generated input to modify a view of the selected waveform so that a scale along at least one of the x-axis or the y-axis changes.

40. A method as in claim 39, wherein a gesture comprising a horizontal motion causes the scale of values along the x-axis to increase and a gesture comprising a vertical motion causes the scale of values along the y-axis to increase.

41. A method as in claim 40, wherein the gesture in the horizontal motion causes the scale of the x-axis to increase without the scale of the y-axis changing and wherein the gesture in the vertical motion causes the scale of the y-axis to increase without the scale of the x-axis changing.
